(19) United States
(12) Patent Application Publication
(10) Pub. No.: US 2025/0338106 A1
(43) Pub. Date: Oct. 30, 2025

(54) METHODS AND SYSTEMS FOR SMART CITY DECENTRALIZED EMERGENCY MANAGEMENT BASED ON AN IOT LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Lei HE, Chengdu (CN); Zhiyun LUO, Chengdu (CN)

(73) Assignee: CHENGDU QINCHUAN IOT TECHNOLOGY CO., LTD., Chengdu (CN)

(21) Appl. No.: 19/263,450

(22) Filed: Jul. 8, 2025

(30) Foreign Application Priority Data
May 15, 2025 (CN) 202510622679.6

(51) Int. Cl. H04W 4/90; G16Y 40/35; G16Y 40/50

(52) U.S. Cl. CPC H04W 4/90; G16Y 40/35; G16Y 40/50

(57) ABSTRACT

The present disclosure relates to a method and a system for smart city decentralized emergency management based on an Internet of Things large model, the method includes: determining at least one incident based on target data; determining a data criticality level and a data emergency feature based on the target data, a data basic feature, the at least one incident and a data anomaly feature; determining at least one target sub-platform based on the target data, the data anomaly feature and a division condition; determining emergency parameters based on the emergency type, the emergency level and the data emergency feature; determining operating parameters of an emergency rescue vehicle based on the emergency level, the emergency parameters and the data emergency feature; generating and transmitting a dispatch instruction based on the emergency parameters and operating parameters; and controlling the emergency rescue vehicle to move to the geographic region.

### CROSS-REFERENCE TO RELATED APPLICATIONS

This application claims priority to Chinese Patent Application No. 202510622679.6, filed on May 15, 2025, the entire content of which is hereby incorporated by reference.

### TECHNICAL FIELD

The present disclosure relates to the field of emergency monitoring, and in particular relates to a method and a system for smart city decentralized emergency management based on an Internet of Things (IoT) large model.

### BACKGROUND

In the construction of a smart city, emergency management is a key link to ensure the safe operation of the city. However, the current emergency management system is still deficient in data processing and resource allocation. On the one hand, the data sources are extensive and complex, and it is difficult to effectively integrate and share data between different departments, leading to the phenomenon of information silos. On the other hand, there is a lack of effective means for analyzing data emergency feature, making it difficult to quickly identify the prioritization and criticality of data.

Therefore, it is desired to provide a method and a system for smart city decentralized emergency management based on an IoT large model, which is capable of realizing accurate determination of a data emergency feature, ensuring efficient utilization of emergency resources, and enhancing the overall efficiency of city emergency management.

### SUMMARY

One or more embodiments of the present disclosure provide a method for smart city decentralized emergency management based on an IoT large model, implemented based on an emergency supervisory management platform, comprising: obtaining, from an emergency supervisory object platform, a plurality of pieces of target data based on a preset period through an emergency supervisory sensing network platform; for each piece of target data in the plurality of pieces of target data: determining, based on the piece of target data, at least one incident corresponding to the piece of target data; determining a data criticality level of the piece of target data based on the piece of target data, a data basic feature of the piece of target data, and the at least one incident; determining a data emergency feature of the piece of target data based on the piece of target data, a data anomaly feature of the piece of target data, and the data criticality level; determining at least one target sub-platform corresponding to the piece of target data based on the piece of target data, the data anomaly feature, and a division condition corresponding to the piece of target data; obtaining an emergency type and an emergency level within a geographic region corresponding to the piece of target data from the at least one target sub-platform; determining emergency parameters based on the emergency type, the emergency level, and the data emergency feature of at least one piece of target data within the geographic region; determining operating parameters of an emergency rescue vehicle based on the emergency level, the emergency parameters, and the data emergency feature of the piece of target data within the geographic region; generating a dispatch instruction based on the emergency parameters and operating parameters, transmitting the dispatch instruction to the emergency supervisory object platform, and controlling the emergency rescue vehicle to move to the geographic region, and controlling the emergency rescue vehicle to operate according to the emergency parameters and operating parameters based on the emergency supervisory object platform.

One or more embodiments of the present disclosure provide a system for smart city decentralized emergency management based on an IoT large model, comprising an emergency supervisory management platform, wherein the emergency supervisory management platform is configured to: obtain, from an emergency supervisory object platform, a plurality of pieces of target data based on a preset period through an emergency supervisory sensing network platform; for each piece of target data in the plurality of pieces of target data: determine, based on the piece of target data, at least one incident corresponding to the piece of target data; determine a data criticality level of the piece of target data based on the piece of target data, a data basic feature of the piece of target data, and the at least one incident; determine a data emergency feature of the piece of target data based on the piece of target data, a data anomaly feature of the piece of target data, and the data criticality level; determine at least one target sub-platform corresponding to the piece of target data based on the piece of target data, the data anomaly feature, and a division condition corresponding to the piece of target data; obtain an emergency type and an emergency level within a geographic region corresponding to the piece of target data from the at least one target sub-platform; determine emergency parameters based on the emergency type, the emergency level, and the data emergency feature of at least one piece of target data within the geographic region; determine operating parameters of an emergency rescue vehicle based on the emergency level, the emergency parameters, and the data emergency feature of the piece of target data within the geographic region; generate a dispatch instruction based on the emergency parameters and operating parameters, transmit the dispatch instruction to the emergency supervisory object platform, and control the emergency rescue vehicle to move to the geographic region, and control the emergency rescue vehicle to operate according to the emergency parameters and operating parameters based on the emergency supervisory object platform.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is an exemplary schematic diagram illustrating a platform structure of a system for smart city decentralized emergency management based on an IoT large model according to some embodiments of the present disclosure;

FIG. 2 is a flowchart illustrating an exemplary process for smart city decentralized emergency management based on an IoT large model according to some embodiments of the present disclosure;

FIG. 3 is a flowchart illustrating an exemplary process for controlling an operation of a display device according to some embodiments of the present disclosure;

FIG. 4 is an exemplary schematic diagram illustrating an emergency prediction model according to some embodiments of the present disclosure;

FIG. 5 is an exemplary schematic diagram illustrating a process for sending a network data packet according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “unit,” and/or “module” as used herein are a way to distinguish between different levels of components, parts, sections, or assemblies. However, the terms may be replaced by other expressions if other terms accomplish the same purpose.

As shown in the present disclosure and the claims, unless the context clearly suggests an exception, the words “one”, “a”, “an” and/or “the” are not singular. They may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the process or device may also include other steps or elements.

Flowcharts are used in the present disclosure to illustrate operations performed by a system according to embodiments of the present disclosure. It should be appreciated that the preceding or following operations are not necessarily performed in an exact sequence. Instead, steps may be processed in reverse order or simultaneously. Also, it is possible to add other operations to these processes or remove a step or steps from them.

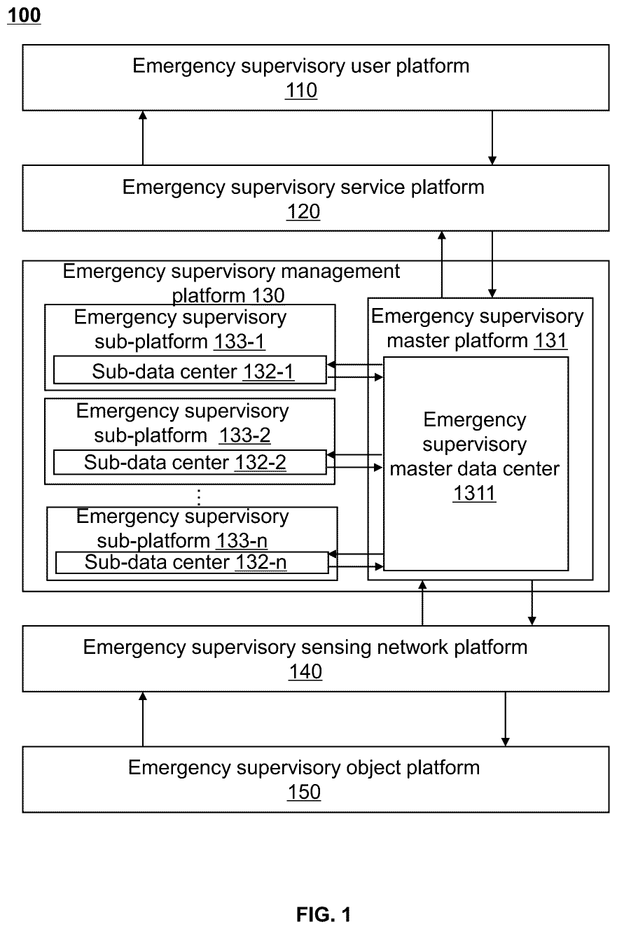

FIG. 1 is an exemplary schematic diagram illustrating a platform structure of a system for smart city decentralized emergency management based on an IoT large model according to some embodiments of the present disclosure. It should be noted that the following embodiments are only used to explain the present disclosure and do not constitute a limitation of the present disclosure.

In some embodiments, as shown in FIG. 1, a system 100 for smart city decentralized emergency management based on an IoT large model may include an emergency supervisory user platform 110, an emergency supervisory service platform 120, an emergency supervisory management platform 130, an emergency supervisory sensing network platform 140, and an emergency supervisory object platform 150. The emergency supervisory user platform 110, the emergency supervisory service platform 120, the emergency supervisory management platform 130, the emergency supervisory sensing network platform 140, and the emergency supervisory object platform 150 are communicatively connected in sequence.

The emergency supervisory user platform 110 refers to a platform for a supervisory user to interact with the system 100. The supervisory user may be a higher-level supervisory authority, a territorial government department, and a territorial public of a regional supervisory authority.

The emergency supervisory service platform 120 refers to a platform for receiving emergency feedback from the emergency supervisory management platform 130 and communicating user requirements and control information. In some embodiments, the emergency supervisory service platform 120 may exchange data with the emergency supervisory user platform 110 and the emergency supervisory master platform 131 of the emergency supervisory management platform 130.

The emergency supervisory management platform 130 refers to a platform for overseeing and managing data related to the system 100. The emergency supervisory management platform 130 may interact with the regional supervisory authority. The regional supervisory authority corresponds to the higher-level supervisory authority corresponding to the emergency supervisory user platform 110. For example, when the higher-level supervisory authority is a provincial emergency supervisory authority, the regional supervisory authority is a municipal emergency supervisory authority.

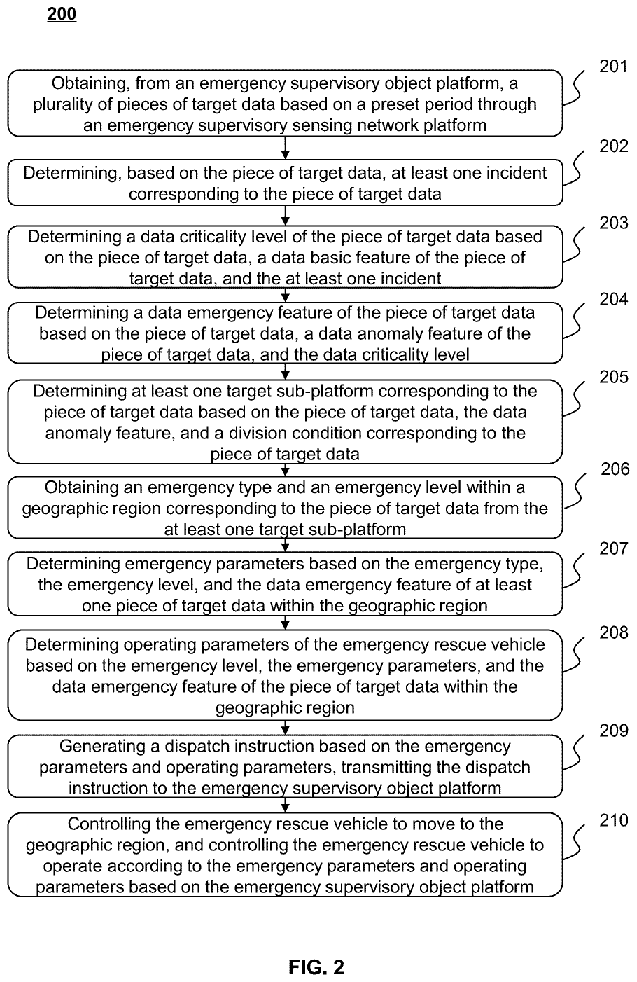

In some embodiments, the emergency supervisory management platform 130 may be configured to: obtain, from the emergency supervisory object platform 150, a plurality of pieces of target data based on a preset period through the emergency supervisory sensing network platform 140; for each piece of target data in the plurality of pieces of target data: determine, based on the piece of target data, at least one incident corresponding to the piece of target data; determine a data criticality level of the piece of target data based on the piece of target data, a data basic feature of the piece of target data, and the at least one incident; determine a data emergency feature of the piece of target data based on the piece of target data, a data anomaly feature of the piece of target data, and the data criticality level; determine at least one target sub-platform corresponding to the piece of target data based on the piece of target data, the data anomaly feature, and a division condition corresponding to the piece of target data; obtain an emergency type and an emergency level within a geographic region corresponding to the piece of target data from the at least one target sub-platform; determine emergency parameters based on the emergency type, the emergency level, and data emergency feature of at least one piece of target data within the geographic region; determine operating parameters of an emergency rescue vehicle based on the emergency level, the emergency parameters, and the data emergency feature of the at least one piece of target data within the geographic region; generate a dispatch instruction based on the emergency parameters and operating parameters, transmit the dispatch instruction to the emergency supervisory object platform 150, and control the emergency rescue vehicle to move to the geographic region, and control the emergency rescue vehicle to operate according to the emergency parameters and operating parameters based on the emergency supervisory object platform 150. More descriptions regarding the emergency supervisory management platform 130 may be found in FIG. 2-FIG. 5 and the related descriptions.

In some embodiments, the emergency supervisory management platform 130 may include the emergency supervisory master platform 131 and a plurality of emergency supervisory sub-platforms.

The emergency supervisory master platform 131 refers to a master platform that manages the plurality of emergency supervisory sub-platforms. In some embodiments, the emergency supervisory master platform 131 includes an emergency supervisory master data center 1311.

The emergency supervisory master data center 1311 refers to a platform used for integrated management of all emergency supervisory data. The emergency supervisory data includes the target data, the dispatch instruction, other data generated in the system 100, etc.

In some embodiments, the emergency supervisory master data center 1311 may include a data coordination processing model library, a coordination management database, and a computing unit, or the like. The data coordination processing model library refers to a library of related computational models for storing emergency supervisory data and coordinating the processing. The data coordination processing model may integrate and categorize, synthesize, and analyze the emergency supervisory data. The coordination management database may be used to store relevant data for integrated analysis and management. The computing unit may be a processing device (e.g., a central processing unit, an embedded processor, etc.).

The emergency supervisory sub-platforms refer to platforms that are used to process different data. In some embodiments, the emergency supervisory sub-platforms may include a prevention sub-platform, a monitoring sub-platform, a response sub-platform, a precautionary sub-platform, or the like. The prevention sub-platform is configured to process anomalous data to predict the occurrence of an emergency incident. The monitoring sub-platform is configured to process normal data to monitor anomalies in real time. The response sub-platform is configured to process anomalous data to determine the real-time status of an emergency incident. The precautionary sub-platform is configured to process data related to incident precautionary measures to prevent reoccurrence of the emergency incident.

In some embodiments, the emergency supervisory sub-platform includes a sub-data center. The sub-data center refers to a platform for managing and storing data of the emergency supervisory sub-platform. The sub-data center may include a sub-database and a sub-data processing model library.

In some embodiments, the sub-data center may exchange data with the emergency supervisory master data center 1311.

In some embodiments, as shown in FIG. 1, the emergency supervisory sub-platform may include an emergency supervisory sub-platform 133-1, an emergency supervisory sub-platform 133-2, . . . , an emergency supervisory sub-platform 133-n. The sub-data center may include a sub-data center 132-1, a sub-data center 132-2 . . . , a sub-data center 132-n. The emergency supervisory sub-platform 133-n corresponds to and exchanges data with the sub-data center 132-n.

The emergency supervisory sensing network platform 140 refers to a platform for performing sensing communications. In some embodiments, the emergency supervisory sensing network platform 140 may be configured as a communication network, a gateway, etc.

In some embodiments, the emergency supervisory sensing network platform 140 may exchange data with the emergency supervisory master platform 131 and the emergency supervisory object platform 150.

The emergency supervisory object platform 150 refers to a platform for capturing data or executing instructions. In some embodiments, the emergency supervisory object platform 150 may include a monitoring device system directly managed by the emergency supervisory management platform 130, a monitoring device system managed by a lower-level supervisory authority, or the like.

The monitoring device system includes a plurality of data acquisition devices, such as a pressure sensor, a temperature sensor, a flow meter, a gas sensor, a video monitor, an infrared sensor, etc.

More descriptions regarding each of the above platforms may be found in FIG. 2-FIG. 5 and the related descriptions.

Communication connections are realized between functional platforms based on the system 100, which can form a closed-loop of information operation between the functional platforms, and coordinate and operate regularly under the unified management of the emergency supervisory management platform, realizing informatization and intellectualization of the emergency supervisory perception and control.

It should be noted that the above descriptions of the system 100 and the constituent platforms are provided only for descriptive convenience and do not limit the present disclosure to the scope of the cited embodiments. It is understood that for a person skilled in the art, with an understanding of the principle of the system, it may be possible to arbitrarily combine various platforms or constitute subsystems to be connected to other platforms without departing from this principle.

FIG. 2 is a flowchart illustrating an exemplary process for smart city decentralized emergency management based on an IoT large model according to some embodiments of the present disclosure. Process 200 refers to an exemplary process for smart city decentralized emergency management based on an IoT large model. In some embodiments, the process 200 is performed by the emergency supervisory management platform 130. The process 200 includes operation 201-operation 210.

Operation 201, obtaining, from an emergency supervisory object platform, a plurality of pieces of target data based on a preset period through an emergency supervisory sensing network platform.

The preset period refers to a period of time for which the emergency supervisory object platform 150 obtains the target data.

In some embodiments, the preset period may be preset by a technician based on experience.

The target data refers to emergency management data of an object to be processed that needs to be processed. For example, the target data may include temperature, pressure, etc. The object to be processed may be a gas system, an electric power system, a water resource system, and a transportation safety system. Taking the gas system as an example, the target data may include at least one of a gas temperature, a gas pressure, a gas flow rate, a concentration of combustible gas or a concentration of poisonous gas, a crowd size around a pipeline, a count of flammable and explosive items, a gas outage duration, etc.

In some embodiments, the emergency supervisory management platform 130 may obtain the target data from data acquisition devices of the emergency supervisory object platform 150 via an emergency supervisory sensing network platform 140.

For each piece of target data in the plurality of pieces of target data, operation 202-operation 210 are performed until all the target data are processed.

Operation 202, determining, based on the piece of target data, at least one incident corresponding to the piece of target data.

The incident may include a leakage incident, a fire incident, an explosion incident, a poisoning incident, an equipment failure incident, or the like.

In some embodiments, the emergency supervisory management platform 130 may look up a first preset table to determine the at least one incident corresponding to the piece of target data based on the piece of target data. The first preset table may include a correspondence between the piece of target data and the at least one incident. The first preset table may be constructed by a technician based on experience or historical data.

Operation 203, determining a data criticality level of the piece of target data based on the piece of target data, a data basic feature of the piece of target data, and the at least one incident.

The data basic feature refers to a basic feature associated with the piece of target data. For example, the data basic feature may include a geographic region to which the piece of target data belongs and a data type (e.g., a text, an image, etc.).

In some embodiments, the emergency supervisory management platform 130 may determine the data basic feature of the piece of target data via a preset algorithm. For example, the preset algorithm may be a recognition algorithm, etc.

The data criticality level refers to an importance level of the piece of target data. The higher the data criticality level is, the higher the importance level of the piece of target data is.

In some embodiments, for each incident in the at least one incident, the emergency supervisory management platform 130 may look up a second preset table to obtain a development rate and a hazard degree of the incident, an importance level of the data type of the piece of target data, and an importance level of the geographic region which the piece of target data belongs to, based on the piece of target data and the at least one incident; take a weighted sum of the development rate and the hazard degree of the incident, the importance level of the data type, and the importance level of the geographic region as the data criticality level, and weights may be set empirically. The second preset table may include the development rate and the hazard degree of each incident corresponding to the piece of target data, the importance levels of different data types, and the importance levels of different geographic regions. The second preset table may be obtained statistically from the historical data or preset by the technician according to the requirements.

Operation 204, determining a data emergency feature of the piece of target data based on the piece of target data, a data anomaly feature of the piece of target data, and the data criticality level.

The data anomaly feature refers to a feature that characterizes whether there is an anomalous state in the piece of target data. For example, the data anomaly feature may include a value of the piece of target data, a changing trend of the piece of target data (e.g., a trend of up or down), etc.

In some embodiments, the emergency supervisory management platform 130 may obtain target data for a plurality of time points in the preset period, to constitute a target data sequence; obtain historical target data constituted by a plurality of historical time points of a preset period and a next time point in historical data to constitute a plurality of historical change sequences, and cluster the plurality of historical change sequences; and determine a cluster in which a historical change sequence is similar to the target data sequence, take a changing trend of subsequent data that accounts for a relatively large proportion as the changing trend of the target data. The historical change sequence reflects a changing trend of the historical target data. For example, if the target data sequence consists of target data at time points t1-t4, the historical change sequence consists of historical target data at historical time points t1-t5, t5 being the next time point of t4. The similarity between the target data sequence and the historical change sequence is greater than a similarity threshold. The similarity is negatively correlated with a vector distance.

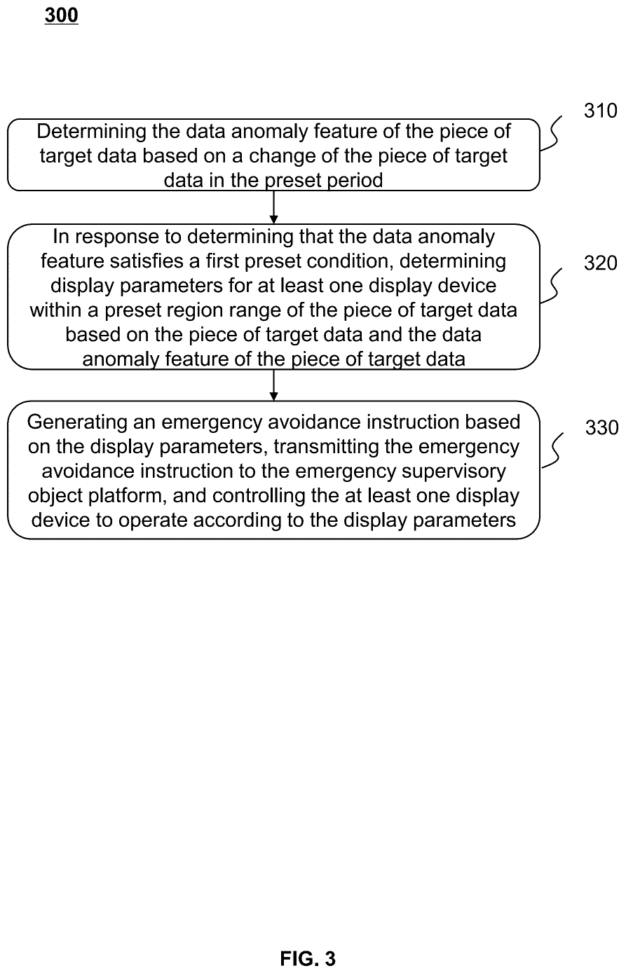

In some embodiments, the emergency supervisory management platform 130 may determine the data anomaly feature of the piece of target data based on a change of the piece of target data in the preset period, more descriptions may be found in FIG. 3 and the related descriptions.

The data emergency feature refers to a feature that reflects the importance level of the piece of target data. For example, the data emergency feature may include the importance level of the piece of target data and a changing trend of the importance level.

In some embodiments, the emergency supervisory management platform 130 may take a weighted sum of the data criticality level of the piece of target data and a difference between a value of the piece of target data and a normal range as the importance level of the piece of target data. The normal range refers to a range in which the target data is located if there is no incident.

In some embodiments, the emergency supervisory management platform 130 may determine the changing trend of the importance level based on the changing trend of the piece of target data. For example, when the value of the piece of target data is less than the normal range, the smaller the value of the target data is, the greater the importance level of the target data is; and when the value of the piece of target data is greater than the normal range, the larger the value of the target data is, the greater the importance level of the target data is.

In some embodiments, the emergency supervisory management platform 130 may determine the data emergency feature of the piece of target data based on at least one piece of associated data, the data anomaly feature, and the data criticality level of the piece of target data, more descriptions may be found in FIG. 3 and the related descriptions.

Operation 205, determining at least one target sub-platform corresponding to the piece of target data based on the piece of target data, the data anomaly feature, and a division condition corresponding to the piece of target data.

The division condition refers to a condition that divides the piece of target data into different target sub-platforms. The division condition may include the value range and the changing trend of the target data divided into each target sub-platform.

In some embodiments, the division condition may be preset by the technician based on experience.

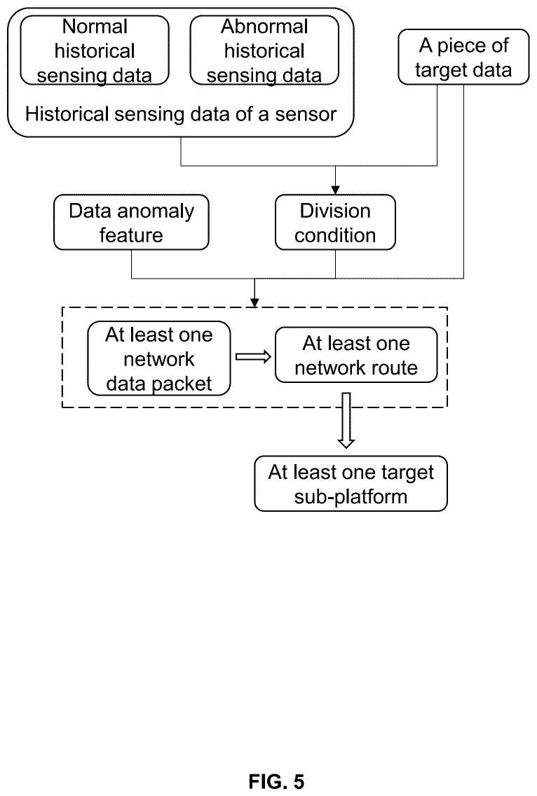

In some embodiments, the emergency supervisory management platform 130 may determine the division condition corresponding to the piece of target data based on the piece of target data and historical sensing data of a sensor corresponding to the piece of target data. More descriptions may be found in FIG. 5 and the related descriptions.

The target sub-platforms refer to platforms that process target data differently.

In some embodiments, the target sub-platforms include platforms in a emergency supervisory sub-platforms (e.g., a prevention sub-platform, a monitoring sub-platform, a response sub-platform, a precautionary sub-platform, etc.), more descriptions may be found in FIG. 1 and the related descriptions.

In some embodiments, the emergency supervisory management platform 130 may match, based on the piece of target data and the data anomaly feature, the division condition to determine the changing trend of the piece of target data and a value range to which the target data belongs in the division condition, thereby determining the target sub-platforms that the piece of target data is sent to.

Operation 206, obtaining an emergency type and an emergency level within a geographic region corresponding to the piece of target data from the at least one target sub-platform.

The geographic region refers to geographic location information where the piece of target data is located. Each geographic region includes at least one piece of target data.

The emergency type refers to a type of work that needs to be performed within the geographic region to which the piece of target data belongs, e.g., monitoring and patrol, prevention, and/or rescue.

The emergency level refers to an emergency level of the incident within the geographic region to which the piece of target data belongs.

In some embodiments, the target sub-platform may analyze and process the received target data to determine the emergency type and the emergency level within the geographic region corresponding to the piece of target data.

In some embodiments, the emergency supervisory management platform 130 obtains the emergency type and the emergency level from the target sub-platform corresponding to the emergency supervisory sub-platform.

Operation 207, determining emergency parameters based on the emergency type, the emergency level, and the data emergency feature of at least one piece of target data within the geographic region.

The emergency parameters refer to parameters related to the execution of the rescue work in the geographic region. For example, the emergency parameters may include a type of the emergency rescue vehicle, a count of emergency rescue vehicles, and an arrival time of the emergency rescue vehicle needed for the geographic region corresponding to the piece of target data. The emergency rescue vehicle include a rescue vehicle, a communication vehicle, a patrol vehicle, a power supply vehicle, or the like.

In some embodiments, the emergency supervisory management platform 130 may determine the type of the emergency rescue based on the emergency type. For example, if the emergency type is the rescue, the emergency rescue vehicle includes the rescue vehicle, the power supply vehicle, and the communication vehicle. For example, if the emergency type is the prevention, the emergency rescue vehicle includes the rescue vehicle, the power supply vehicle, the communication vehicle, and the patrol vehicle. Further, if the emergency type is the monitoring and patrol, the emergency rescue vehicle includes the patrol vehicle.

In some embodiments, the emergency supervisory management platform 130 may determine the count of the emergency rescue vehicles based on a weighted sum of the emergency level within the geographic region and an average importance level of the at least one piece of target data; in response to determining that the weighted sum is greater than a first preset threshold, dispatch a maximum count of the emergency rescue vehicles to the geographic region; in response to determining that the weighted sum is less than or equal to the first preset threshold, dispatch a standard count of the emergency rescue vehicles to the geographic region.

The first preset threshold, the maximum count, and the standard count may be preset by a technician based on experience.

Operation 208, determining operating parameters of the emergency rescue vehicle based on the emergency level, the emergency parameters, and the data emergency feature of the piece of target data within the geographic region.

In some embodiments, the operating parameters may include a rescue parameter of the emergency rescue vehicle, a patrol parameter of the patrol vehicle, and/or a power supply parameter of the power supply vehicle. The rescue parameter includes a monitoring frequency of the sensor (e.g., a temperature sensor, a pressure sensor, a gas concentration sensor, etc.) on the rescue vehicle and operating parameters of a ventilation device (e.g., a ventilation time period and a ventilation power of the ventilation device, etc.). The patrol parameter includes a patrol frequency and/or a patrol time of the patrol vehicle, and the power supply parameter includes a power generation capacity of the power supply vehicle.

In some embodiments, the emergency supervisory management platform 130 may determine the operating parameters of the emergency rescue vehicle by looking up a third preset table based on the emergency level, the emergency parameters, and the data emergency feature of the at least one piece of target data. The third preset table includes the emergency level, the emergency parameters, the data emergency feature of the piece of target data, and the corresponding operating parameters of the emergency rescue vehicle. The third preset table may be preset by a technician based on historical data or requirements.

Operation 209, generating a dispatch instruction based on the emergency parameters and operating parameters, transmitting the dispatch instruction to the emergency supervisory object platform.

The dispatch instruction refers to an instruction used to dispatch the emergency rescue vehicle. The dispatch instruction may include a control instruction for scheduling the emergency rescue vehicle to drive to the geographic region and a control instruction for controlling the emergency rescue vehicle to operate in accordance with the operating parameters.

Operation 210, controlling the emergency rescue vehicle to move to the geographic region, and controlling the emergency rescue vehicle to operate according to the emergency parameters and operating parameters based on the emergency supervisory object platform.

In some embodiments, the emergency supervisory object platform 150 may control the sensor set on the rescue vehicle to monitor the environment around the rescue vehicle at a monitoring frequency; control a ventilation device set on the rescue vehicle to ventilate with the ventilation power to carry out ventilation during a ventilation time period; control a power supply device set on the power supply vehicle to supply power to the geographic region with the power generation capacity; and control the patrol vehicle to patrol the geographic region with the patrol frequency and the patrol time.

In some embodiments of the present disclosure, the incident is determined based on the piece of target data, which in turn determines the data criticality level and the data emergency feature of the piece of target data, and the corresponding target sub-platforms, the geographic region, the emergency type, the emergency level, and the emergency parameters, which in turn determines the operating parameters of the emergency rescue vehicle, and controls the operating of the emergency rescue vehicle, which is conducive to accurately responding to the incident, hierarchically classifying and deploying emergency resources, improving emergency rescue efficiency, reducing the likelihood of the incident, and reducing the loss caused by the incident.

It should be noted that the foregoing description of the process 200 is intended to be merely exemplary and illustrative, and does not limit the scope of application of the present disclosure. For a person skilled in the art, various modifications and changes can be made to the process 200 under the guidance of this disclosure. However, these modifications and changes remain within the scope of this disclosure.

FIG. 3 is a flowchart illustrating an exemplary process for controlling an operation of a display device according to some embodiments of the present disclosure. Process 300 refers to an exemplary process for controlling the operation of the display device. In some embodiments, the process 300 may be performed by the emergency supervisory management platform 130. As shown in FIG. 3, the process 300 includes operation 310-operation 330 described below.

Operation 310, determining a data anomaly feature of the piece of target data based on a change of the piece of target data in a preset period.

The change of the piece of target data in the preset period may be a change curve. Horizontal coordinates of the change curve represent a plurality of time points in the preset period, and vertical coordinates represent values of the piece of target data corresponding to the plurality of time points.

In some embodiments, the emergency supervisory management platform 130 may construct a plurality of coordinate points using the plurality of time points in the preset period as the horizontal coordinates, and the values of the piece of target data corresponding to the plurality of time points as vertical coordinates; in response to a count of the coordinate points being greater than or equal to a preset count threshold, the plurality of coordinate points are sequentially connected to form the change curve. In response to determining that the count of the coordinate points is less than the preset count threshold, the emergency supervisory management platform 130 may divide all of the coordinate points into different point sets according to a preset time range; for each point set, supplementally obtaining target data of at least one time point within a time range corresponding to the point set via an emergency supervisory sensing network platform 140 from an emergency supervisory object platform 150, construct supplemental coordinate points based on values and time points of supplementally obtained target data, and form the change curve via fitting the supplemental coordinate points to original coordinate points.

In some embodiments, the preset time range and the preset count threshold may be preset by a technician based on need or experience. In some embodiments, the preset count threshold is positively correlated with a distribution breadth of the geographic region of the plurality of pieces of target data. The distribution breadth of the geographic region may be expressed as a total count of geographic regions to which the plurality of pieces of target data respectively belongs. The larger the distribution breadth of the geographic region, the more complex a data pattern, and the larger the preset count threshold.

In some embodiments, the emergency supervisory management platform 130 may add the supplemental coordinate points to the point set, and fit each point set by a fitting model or a fitting algorithm to obtain the change curve.

In some embodiments, the emergency supervisory object platform 150 may supplementally obtain target data for at least one time point within the time range corresponding to the point set by data acquisition devices. The time points corresponding to the supplementally obtained target data are different from original time points.

In some embodiments, for each piece of target data, the emergency supervisory management platform 130 may take a value of the piece of target data corresponding to a current time point in the change curve of the piece of target data and a first-order derivative of the change curve at the current time point as the data anomaly feature of the piece of target data.

In some embodiments, there is an association relationship between the plurality of pieces of target data. For the piece of target data, the emergency supervisory management platform 130 may also configured to obtain at least one piece of associated data of the piece of target data and generate at least one associated data pair; determine at least one associated anomaly feature of the at least one associated data pair based on a change of the at least one associated data pair in the preset period; and determine the data emergency feature of the piece of target data based on the at least one associated anomaly feature, and the data anomaly feature and the data criticality level of the piece of target data.

The association relationship between the plurality of pieces of target data reflects that the plurality of pieces of target data have an association effect on the same incident. For example, in the incident of emergency supervisory of the gas system, for gas pressure data, there is an associated relationship between a gas temperature, a gas flow rate, etc., and gas pressure when there is a gas leakage incident and/or a gas blockage incident.

The associated data refers to data that has an association with the current target data.

In some embodiments, the emergency supervisory management platform 130 may obtain the associated data of the piece of target data from a target sub-platform corresponding to the target data.

The associated data pair may include a pair of pieces of target data that have an association relationship.

In some embodiments, the emergency supervisory management platform 130 may generate a plurality of associated data pairs based on the pieces of target data and a plurality of associated data of the pieces of target data, respectively.

In some embodiments, an associated data pair of the at least one associated data pair further includes an associated incident, and the emergency supervisory management platform 130 may further configured to generate the at least one associated data pair based on the piece of target data, the at least one piece of associated data of the piece of target data, and the at least one incident.

The associated incident refers to an incident on which the data in an associated data pair has a common impact. For example, in the case of emergency supervisory of the gas system, the gas pressure data and the gas temperature both affect the gas leakage incident and the gas blockage incident, and the associated data pair consisting of the gas pressure data and the gas temperature also includes the gas leakage incident and the gas blockage incident.

In some embodiments of the present disclosure, the associated data pairs also take a specific associated incident into account, so that the associated data pair clearly reflects an association relationship between a pair of pieces of target data, and so that the subsequent parameters determined based on the associated data pair are more accurate and reliable.

The associated anomaly feature refers to a feature that characterizes whether an anomalous state exists in the associated data. For example, the associated anomaly feature may include a value of the associated data, a changing trend of the associated data.

The associated anomaly feature is determined in the same way as the data anomaly feature in FIG. 2, more descriptions may be found in FIG. 2 and the related description.

In some embodiments, the emergency supervisory management platform 130 may determine the data emergency feature of the piece of target data in various ways based on the at least one associated anomaly feature, the data anomaly feature of the piece of target data, and the data criticality level.

For example, the emergency supervisory management platform 130 may take a weighted sum of the data criticality level, differences between the values of the plurality of associated data and the normal range, and a difference between the value of the piece of target data and the normal range as an importance level of the piece of target data; update, based on changing trends of the plurality of associated data, a changing trend of the piece of target data, and determine a changing trend of the importance level based on the changing trend of the piece of target data. More descriptions regarding determining the changing trend of importance level may be found in FIG. 2 and the related descriptions.

The emergency supervisory management platform 130 may determine the changing trend of the piece of target data via a fourth preset table based on the changing trends of the plurality of associated data. The fourth preset table includes a correspondence between the changing trends of the plurality of associated data and the changing trend of the piece of target data. The fourth preset table may be obtained by counting historical data.

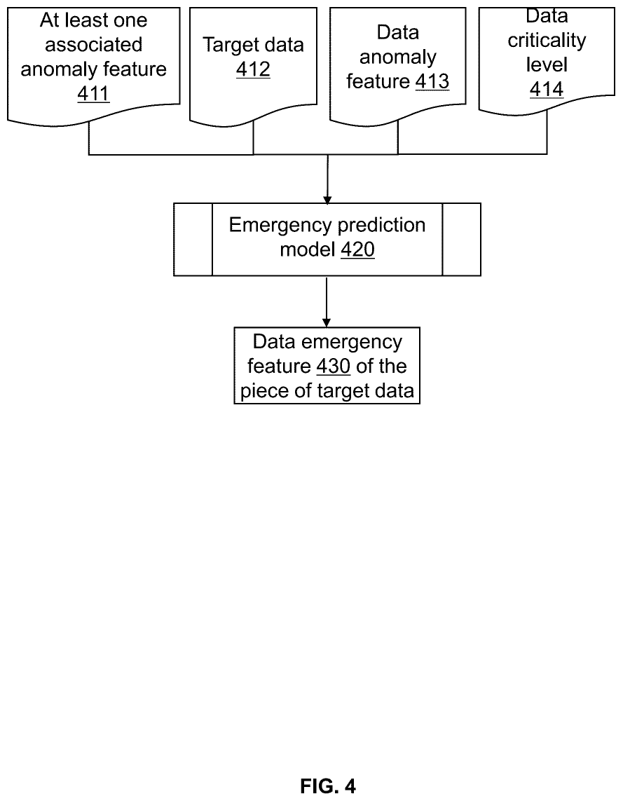

In some embodiments, the emergency supervisory management platform 130 may determine the data emergency feature of the piece of target data through an emergency prediction model, more descriptions may be found in FIG. 4 and the related descriptions.

In some embodiments of the present disclosure, determining the data emergency feature based on the associated anomaly feature, and the data anomaly feature and the data criticality level of the piece of target data, is conducive to improving the accuracy of the associated data pair, thereby improving effect of a risk assessment, and enhancing capability of the incident early warning.

Operation 320, in response to determining that the data anomaly feature satisfies a first preset condition, determining display parameters for at least one display device within a preset region range of the piece of target data based on the piece of target data and the data anomaly feature of the piece of target data.

The first preset condition includes a value range of target data to be sent to a response sub-platform.

In some embodiments, the emergency supervisory management platform 130 may take a division condition of the piece of target data that is sent to the response sub-platform as the first preset condition.

The preset region range refers to a geographic range within the geographic region to which the piece of target data belongs.

In some embodiments, the preset region range may be preset by a technician based on experience.

The display device refers to a device for displaying and alerting an abnormal situation. For example, the display device may include a warning light, a warning sign, or the like. A plurality of display devices may be provided within each geographic region.

The display parameters refer to operating parameters of the display device. For example, the display parameters may include a display frequency of the display device (e.g., a blinking frequency of the warning light) and a display color, etc.

In some embodiments, the emergency supervisory management platform 130 may determine the display parameters of the display device by querying a fifth preset table based on the piece of target data and the data anomaly feature. The fifth preset table may include target data, data anomaly feature of the target data, and corresponding display parameters (including the display frequency and the display color). The fifth preset table may be set by a technician based on historical data or experience.

Operation 330, generating an emergency avoidance instruction based on the display parameters, transmitting the emergency avoidance instruction to the emergency supervisory object platform, and controlling the at least one display device to operate according to the display parameters.

The emergency avoidance instruction refers to an instruction for controlling the display device to operate. In some embodiments, the emergency supervisory management platform 130 may send the emergency avoidance instruction to the emergency supervisory object platform 150 via the emergency supervisory sensing network platform 140 to control the display device within the emergency supervisory object platform 150 to operate according to the display parameters.

In some embodiments of the present disclosure, based on the change of the piece of target data within the preset period, the data anomaly feature of the piece of target data is determined, and the display parameters of the piece of target data are determined, and then the emergency avoidance instruction is generated, which controls the display device to operate. The above manner is conducive to dynamically adjusting the display parameters, quickly generating and executing the emergency avoidance instruction, improving the efficiency of the emergency response, and enhancing the public ability to avoid danger in an emergency.

It should be noted that the foregoing description of the process 300 is intended to be exemplary and illustrative only and does not limit the scope of application of the present disclosure. For a person skilled in the art, various modifications and changes can be made to the process under the guidance of this disclosure. However, these modifications and changes remain within the scope of this disclosure.

In some embodiments, the emergency supervisory management platform 130 may determine the data emergency feature of the piece of target data through the emergency prediction model based on the at least one associated anomaly feature, the piece of target data, the data anomaly feature, and the data criticality level.

The emergency prediction model refers to a model used to determine the data emergency feature for the piece of target data. In some embodiments, the emergency prediction model may be a machine learning model, e.g., a Deep Neural Network (DNN), etc.

FIG. 4 is an exemplary schematic diagram illustrating an emergency prediction model according to some embodiments of the present disclosure.

In some embodiments, as shown in FIG. 4, an input of the emergency prediction model 420 may include the at least one associated anomaly feature 411, the piece of target data 412, the data anomaly feature 413, and the data criticality level 414, and an output of the emergency prediction model 420 may include the emergency data emergency feature 430 of the piece of target data.

In some embodiments, the emergency prediction model may be obtained by training based on a plurality of training samples with training labels. A set of training sample may include a plurality of sample associated anomaly features, a piece of sample target data, a sample data anomaly feature, and a sample data criticality level. The training label corresponding to the set of training sample is a data emergency feature of the piece of sample target data.

The training samples may be determined based on historical data. The historical data includes historical associated anomaly features, a plurality of pieces of historical target data, historical data anomaly features, and historical data criticality levels. For each training sample, the emergency supervisory management platform 130 may look up the historical data to obtain a plurality of historical incidents at historical time points of the piece of sample target data corresponding to the training sample, and determine a weighted sum of impact ranges and damages of the historical incidents (weights may be preset empirically) and the changing trends of the damages caused by the historical incidents in a next time period, as the training label.

In some embodiments, the emergency supervisory management platform 130 may conduct a plurality of rounds of iterative training of an initial emergency prediction model based on the plurality of training samples with the training labels until the training is terminated when an iteration condition is satisfied, thereby obtaining a trained emergency prediction model. A round of iterative training includes: inputting a set of training sample with a training label into the initial emergency prediction model, determining a loss function value based on the training label and an output of the initial emergency prediction model, and iteratively updating the parameters of the initial emergency prediction model based on the loss function value. The iterative method may include a gradient descent method, etc. The iteration condition may include that the loss function converges, the number of iterations reaches a preset number of times threshold, the value of the loss function is less than a preset function value threshold, etc.

In some embodiments of the present disclosure, determining the data emergency feature of the target data by the emergency prediction model, the influence of a plurality of factors (such as the associated anomaly feature, the piece of target data, the data anomaly feature, the data criticality level, or the like) on the data emergency feature is considered, that is conducive to accurately predicting the data emergency feature (including the importance level of the piece of target data and the changing trend in the importance level) by utilizing the learning capability of the machine learning model, thereby improving the efficiency of emergency response.

FIG. 5 is an exemplary schematic diagram illustrating a process for sending a network data packet according to some embodiments of the present disclosure.

In some embodiments, as shown in FIG. 5, the emergency supervisory management platform 130 may obtain historical sensing data of a sensor corresponding to a piece of target data, wherein the historical sensing data includes normal historical sensing data and abnormal historical sensing data; determine a division condition corresponding to the piece of target data based on the historical sensing data and the piece of target data; generate at least one network data packet and at least one network route based on the piece of target data, a data anomaly feature of the piece of target data, and the division condition; and transmit the at least one network data packet to at least one target sub-platform through the at least one network route.

The sensor corresponding to the piece of target data refers to a sensor used to acquire the piece of target data in the emergency supervisory object platform 150.

The historical sensing data refers to target data acquired by the sensor corresponding to the piece of target data at a historical time point. The normal historical sensing data refers to relevant target data acquired when no incident occurred. The abnormal historical sensing data refers to relevant target data acquired when an incident occurred.

In some embodiments, the historical sensing data may include a preset count of pieces of data acquired by the sensor during a historical incident time period. The preset count may be set as desired.

In some embodiments, the emergency supervisory object platform 150 may separately count upper limit values and lower limit values of a plurality of pieces of normal historical sensing data and a plurality of pieces of abnormal historical sensing data, take a value range of the upper limit value and the lower limit value of the plurality of pieces of normal historical sensing data as a value range of the piece of target data to be sent to a monitoring sub-platform; determine intersections of the upper limit value and the lower limit value of the plurality of pieces of normal historical sensing data and the upper limit value and the lower limit value of the plurality of pieces of abnormal historical sensing data, as a value range of the piece of target data to be sent to a prevention sub-platform or a precautionary sub-platform; and determine a value range of the upper limit value and the lower limit value of the plurality of pieces of abnormal historical sensing data as a value range of the piece of target data to be sent to a response sub-platform.

The network data packet refers to a basic unit in network communication, including a source address, a destination address, and actual data to be transmitted (e.g., a text, an image, a video stream). The network route refers to a transmission process and a path that transmits the network data packet from the emergency supervisory object platform 150 to the target sub-platform.

In some embodiments, the emergency supervisory object platform 150 may determine, based on the piece of target data, the data anomaly feature and the division condition of the piece of target data, the target sub-platform(s) to which the piece of target data needs to be sent; generate the network data packet(s), a count of which corresponding to a count of target sub-platform(s), and the at least one network route for communicating with the target sub-platform(s), based on the target sub-platform(s) and the piece of target data.

In some embodiments of the present disclosure, determining the division condition of the target data based on the historical sensing data may enable the determined division condition to be more accurate, so that the target data can be correctly assigned to the corresponding target sub-platform.

In some embodiments, the division condition further includes at least one sub-division condition of the at least one incident corresponding to the piece of target data. For each incident in the at least one incident, the emergency supervisory object platform 150 may obtain at least one associated data corresponding to the incident and the piece of target data; determine a sub-division condition corresponding to the incident based on the piece of target data, the historical sensing data of the piece of target data, and associated historical sensing data corresponding to the at least one piece of associated data; determine the at least one target sub-platform corresponding to the piece of target data based on the data anomaly feature of the piece of target data and the sub-division condition; generate the at least one network data packet and the at least one network route based on the piece of target data, the data anomaly feature of the piece of target data, and the sub-division condition; and transmit the at least one network data packet to the at least one target sub-platform through the at least one network route.

More descriptions regarding obtaining the target data and associated data may be found in FIG. 3 and related descriptions.

The associated historical sensing data refers to target data at a historical time point captured by the sensor corresponding to the associated data, including first sensing data and second sensing data. The first sensing data and the second sensing data represent target data captured by the sensor corresponding to the associated data at the historical time when an incident occurred and when no incident occurred, respectively.

In some embodiments, the emergency supervisory object platform 150 may cluster the abnormal historical sensing data corresponding to certain target data based on at least one incident corresponding to the target data; and for each cluster obtained after clustering: obtain the first sensing data of a plurality of pieces of associated data corresponding to the abnormal historical sensing data in the cluster; and in response to determining that the first sensing data corresponding to an acquisition time period that is earlier than or partially earlier than an acquisition time period corresponding to the abnormal historical sensing data, add the first sensing data of which the acquisition time period is earlier than the acquisition time period of the abnormal historical sensing data, to and update the abnormal historical sensing data. More descriptions regarding the abnormal historical sensing data may be found in FIG. 5 and related descriptions.

The sub-division condition refers to a division condition for target data corresponding to different incidents. The sub-division condition may include a value range and a changing trend of target data corresponding to the different incidents divided to each target sub-platform.

In some embodiments, the emergency supervisory object platform 150 may determine the sub-division condition for different incidents based on the normal historical sensing data and the upper limit values and the lower limit values of the abnormal historical sensing data within the respective clusters. More descriptions regarding the specific determination manner may be found in FIG. 5 and related descriptions.

In some embodiments, the emergency supervisory management platform 130 may match the sub-division condition based on the piece of target data and the data anomaly feature to determine the changing trend of the piece of target data and a value range to which the piece of target data belongs in the sub-division condition, thereby determining the target sub-platform to which the target data should be sent.

The network data packet and the network route are determined in a way similar to FIG. 5, more descriptions may be found in FIG. 5 and the related descriptions.

In some embodiments of the present disclosure, for different incidents, the target data may be in different incident phases, and it is possible to assign target data corresponding to different incidents in a targeted manner to a suitable target sub-platform by the sub-division condition. For some incidents, the target data has a lag, the time period in which the incident occurred is determined by considering the associated data and the associated historical sensing data, thereby determining the real value range of the target data at the time when the incident is really occurred, and determining the exact sub-division condition.

In some embodiments, the emergency supervisory management platform 130 may determine an abnormal duration distribution of the sensor based on the historical sensing data; determine an incident phase of the piece of target data based on the historical sensing data and the piece of target data; determine data upload parameters for a next preset period based on the piece of target data, the incident phase, and the abnormal duration distribution; and generate a sensor control instruction based on the data upload parameters, transmit the sensor control instruction to the emergency supervisory object platform, and control the sensor to operate according to the data upload parameters.

More descriptions regarding the historical sensing data may be found in FIG. 5 and the related descriptions.

The abnormal duration distribution includes a time period during which the sensor consistently captures anomalous data (i.e., data at the time of the incident) and the anomalous data.

In some embodiments, the abnormal duration distribution may be obtained by counting the historical sensing data.

The incident phase includes an incident initial phase, an incident peak phase, an incident calm phase, and an incident prevention phase.

In some embodiments, the emergency supervisory management platform 130 may draw a plurality of candidate phase curves based on abnormal historical sensing data corresponding to the plurality of incidents; and determine a standard incident phase curve by subjecting a weighted sum of the plurality of candidate phase curves (weights may be set empirically). The candidate phase curves are plotted in a way similar to the change curve, more descriptions may be found in FIG. 3 and the related descriptions.

In some embodiments, the emergency supervisory management platform 130 may determine the incident phase in which the piece of target data is located by the standard incident phase curve, based on the value and the changing trend of the piece of target data. In response to determining that the value of the piece of target data is within a value range corresponding to a first time period in the standard incident phase curve, the piece of target data is determined in the peak incident phase. The first time period refers to a preset time period before and after a peak (set on requirements). In response to determining that the value of the piece of target data is within a value range corresponding to a second time period in the standard incident phase curve, then the piece of target data is determined in the incident initial phase or in the incident calm phase. The second time period refers to a time period away from the peak, and the second time period may be a time period in the standard incident phase curve other than the first time period. In response to determining that the value of the piece of target data is not within a value range of the standard incident phase curve, the piece of target data is determined in the incident prevention phase.

The data upload parameters include an uploading frequency and an uploading amount of the target data.

In some embodiments, the emergency supervisory management platform 130 may look up a sixth preset table to determine the data upload parameters during a next preset period based on the piece of target data, incident phases, and the abnormal duration distribution. The sixth preset table includes a correspondence between the target data, the incident phase, the abnormal duration distribution and the data upload parameters. The sixth preset table may be preset by a technician.

The sensor control instruction refers to an instruction used to adjust the data upload parameters of the sensor.

The data upload parameters of the sensor in the next period are adjusted based on the abnormal duration distribution and the incident phase, thereby making the parameters captured and uploaded by the sensor more in line with the actual requirements, and improving data capturing efficiency of the sensor.

In some embodiments, the emergency rescue vehicle is equipped with a display component. The emergency supervisory management platform 130 may generate a display instruction based on the incident phase of the piece of target data, transmit the display instruction to the emergency supervisory object platform, and control the display component to operate based on the display instruction.

The display component refers to an element used to indicate the occurrence of an incident. The display component may be a warning light, etc.

The display instruction refers to an instruction that controls the operation of the display component. The display instruction includes a display frequency and a display color of the display component.

In some embodiments, the emergency supervisory management platform 130 may determine different display modes of the display component using a seventh preset table based on the incident phase, and convert the different display modes into the display instruction. The different display modes correspond to different display frequencies and/or display colors. The seventh preset table includes display modes corresponding to different incident phases. The seventh preset table may be set on requirements.

By setting the display component to show the different incident phases of an incident, it can provide timely and accurate warnings of the occurrence of the incident, thus facilitating the timely investigation and treatment of the incident.

The basic concepts have been described above, and it is apparent to those skilled in the art that the foregoing detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. For example, “some embodiments” means a particular feature, structure, or characteristic associated with at least one embodiment of the present disclosure. Accordingly, it should be emphasized and noted that two or more references to “some embodiments” in different places in the present disclosure do not necessarily refer to the same embodiment. Additionally, certain features, structures, or characteristics of one or more embodiments of the present disclosure may be suitably combined.

Additionally, unless expressly stated in the claims, the order of the processing elements and sequences described herein, the use of numerical letters, or the use of other names are not intended to qualify the flow of the present disclosure and the order of the laminar flow hood. While the above-described system components can be implemented by hardware devices, it is also possible to implement them through software-only solutions, such as installing the described system on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes group multiple features together in a single embodiment, accompanying drawings, or in a description thereof. However, this method of disclosure does not imply that more features are required for the objects of the present disclosure than are mentioned in the claims. Rather, claimed subject matter may lie in less than all features of a single foregoing disclosed embodiment.

In some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for smart city decentralized emergency management based on an Internet of Things (IoT) large model, implemented based on an emergency supervisory management platform, comprising:
obtaining, from an emergency supervisory object platform, a plurality of pieces of target data based on a preset period through an emergency supervisory sensing network platform;
for each piece of target data in the plurality of pieces of target data:
determining, based on the piece of target data, at least one incident corresponding to the piece of target data;
determining a data criticality level of the piece of target data based on the piece of target data, a data basic feature of the piece of target data, and the at least one incident;
determining a data emergency feature of the piece of target data based on the piece of target data, a data anomaly feature of the piece of target data, and the data criticality level;
determining at least one target sub-platform corresponding to the piece of target data based on the piece of target data, the data anomaly feature, and a division condition corresponding to the piece of target data; and
obtaining an emergency type and an emergency level within a geographic region corresponding to the piece of target data from the at least one target sub-platform;
determining emergency parameters based on the emergency type, the emergency level, and the data emergency feature of at least one piece of target data within the geographic region;
determining operating parameters of an emergency rescue vehicle based on the emergency level, the emergency parameters, and the data emergency feature of the piece of target data within the geographic region;
generating a dispatch instruction based on the emergency parameters and the operating parameters, transmitting the dispatch instruction to the emergency supervisory object platform; and
controlling the emergency rescue vehicle to move to the geographic region, and controlling the emergency rescue vehicle to operate according to the emergency parameters and the operating parameters based on the emergency supervisory object platform.

2. The method of claim 1, further comprising:
determining the data anomaly feature of the piece of target data based on a change of the piece of target data in the preset period;
in response to determining that the data anomaly feature satisfies a first preset condition, determining display parameters for at least one display device within a preset region range of the piece of target data based on the piece of target data and the data anomaly feature of the piece of target data; and
generating an emergency avoidance instruction based on the display parameters, transmitting the emergency avoidance instruction to the emergency supervisory object platform, and controlling the at least one display device to operate according to the display parameters.

3. The method of claim 2, wherein there is an association relationship between the plurality of pieces of target data, and the method further comprises:
for each piece of target data in the plurality of pieces of target data:
obtaining at least one piece of associated data of the piece of target data and generating at least one associated data pair;
determining at least one associated anomaly feature of the at least one associated data pair based on a change of the at least one associated data pair in the preset period; and
determining the data emergency feature of the piece of target data based on the at least one associated anomaly feature, the data anomaly feature of the piece of target data, and the data criticality level.

4. The method of claim 3, wherein an associated data pair of the at least one associated data pair further includes an associated incident, and obtaining the at least one piece of associated data of the piece of target data and generating the at least one associated data pair includes:
generating the at least one associated data pair based on the piece of target data, the at least one piece of associated data of the piece of target data, and the at least one incident.

5. The method of claim 3, wherein the determining the data emergency feature of the piece of target data based on the at least one associated anomaly feature, the data anomaly feature of the piece of target data, and the data criticality level includes:
determining the data emergency feature of the piece of target data through an emergency prediction model based on the at least one associated anomaly feature, the piece of target data, the data anomaly feature, and the data criticality level, wherein the emergency prediction model is a machine learning model.

6. The method of claim 1, further comprising:
obtaining historical sensing data of a sensor corresponding to the piece of target data, wherein the historical sensing data includes normal historical sensing data and abnormal historical sensing data;
determining the division condition corresponding to the piece of target data based on the historical sensing data and the piece of target data;
generating at least one network data packet and at least one network route based on the piece of target data, the data anomaly feature of the piece of target data, and the division condition; and
transmitting the at least one network data packet to the at least one target sub-platform through the at least one network route.

7. The method of claim 6, further comprising:
determining an abnormal duration distribution of the sensor based on the historical sensing data;
determining an incident phase of the piece of target data based on the historical sensing data and the piece of target data;
determining data upload parameters for a next preset period based on the piece of target data, the incident phase, and the abnormal duration distribution; and
generating a sensor control instruction based on the data upload parameters, transmitting the sensor control instruction to the emergency supervisory object platform, and controlling the sensor to operate according to the data upload parameters.

8. The method of claim 7, wherein the emergency rescue vehicle is equipped with a display component, and the method further comprises:
generating a display instruction based on the incident phase of the piece of target data, transmitting the display instruction to the emergency supervisory object platform, and controlling the display component to operate based on the display instruction.

9. The method of claim 6, wherein the division condition further includes at least one sub-division condition of the at least one incident corresponding to the piece of target data, and the method further comprises:
for each incident in the at least one incident:
obtaining at least one piece of associated data corresponding to the incident and the piece of target data;
determining a sub-division condition corresponding to the incident based on the piece of target data, the historical sensing data of the piece of target data, and associated historical sensing data corresponding to the at least one piece of associated data;
determining the at least one target sub-platform corresponding to the piece of target data based on the data anomaly feature of the piece of target data and the sub-division condition;
generating the at least one network data packet and the at least one network route based on the piece of target data, the data anomaly feature of the piece of target data, and the sub-division condition; and
transmitting the at least one network data packet to the at least one target sub-platform through the at least one network route.

10. A system for smart city decentralized emergency management based on an Internet of Things (IoT) large model, comprising an emergency supervisory management platform,
wherein the emergency supervisory management platform is configured to:
obtain, from an emergency supervisory object platform, a plurality of pieces of target data based on a preset period through an emergency supervisory sensing network platform;
for each piece of target data in the plurality of pieces of target data:
determine, based on the piece of target data, at least one incident corresponding to the piece of target data;
determine a data criticality level of the piece of target data based on the piece of target data, a data basic feature of the piece of target data, and the at least one incident;
determine a data emergency feature of the piece of target data based on the piece of target data, a data anomaly feature of the piece of target data, and the data criticality level;
determine at least one target sub-platform corresponding to the piece of target data based on the piece of target data, the data anomaly feature, and a division condition corresponding to the piece of target data; and
obtain an emergency type and an emergency level within a geographic region corresponding to the piece of target data from the at least one target sub-platform;
determine emergency parameters based on the emergency type, the emergency level, and the data emergency feature of at least one piece of target data within the geographic region;
determine operating parameters of an emergency rescue vehicle based on the emergency level, the emergency parameters, and the data emergency feature of the piece of target data within the geographic region;
generate a dispatch instruction based on the emergency parameters and the operating parameters, transmit the dispatch instruction to the emergency supervisory object platform; and
control the emergency rescue vehicle to move to the geographic region, and control the emergency rescue vehicle to operate according to the emergency parameters and the operating parameters based on the emergency supervisory object platform.

11. The system of claim 10, further comprising: an emergency supervisory user platform, an emergency supervisory service platform, an emergency supervisory sensing network platform, and an emergency supervisory object platform, wherein the emergency supervisory user platform, the emergency supervisory management platform, the emergency supervisory service platform, the emergency supervisory sensing network platform, and the emergency supervisory object platform are communicatively connected in sequence.

12. The system of claim 10, wherein the emergency supervisory management platform is further configured to:
determine the data anomaly feature of the piece of target data based on a change of the piece of target data in the preset period;
in response to determining that the data anomaly feature satisfies a first preset condition, determine display parameters for at least one display device within a preset region range of the piece of target data based on the piece of target data and the data anomaly feature of the piece of target data; and
generate an emergency avoidance instruction based on the display parameters, transmit the emergency avoidance instruction to the emergency supervisory object platform, and control the at least one display device to operate according to the display parameters.

13. The system of claim 12, wherein there is an association relationship between the plurality of pieces of target data, wherein the emergency supervisory management platform is further configured to:
for each piece of target data in the plurality of pieces of target data:
obtain at least one piece of associated data of the piece of target data and generating at least one associated data pair;
determine at least one associated anomaly feature of the at least one associated data pair based on a change of the at least one associated data pair in the preset period; and
determine the data emergency feature of the piece of target data based on the at least one associated anomaly feature, the data anomaly feature of the piece of target data, and the data criticality level.

14. The system of claim 13, wherein an associated data pair of the at least one associated data pair further includes an associated incident, and the emergency supervisory management platform is further configured to:
generate the at least one associated data pair based on the piece of target data, the at least one piece of associated data of the piece of target data, and the at least one incident.

15. The system of claim 13, wherein the emergency supervisory management platform is further configured to:
determine the data emergency feature of the piece of target data through an emergency prediction model based on the at least one associated anomaly feature, the piece of target data, the data anomaly feature, and the data criticality level, wherein the emergency prediction model is a machine learning model.

16. The system of claim 10, wherein the emergency supervisory management platform is further configured to:
obtain historical sensing data of a sensor corresponding to the piece of target data, wherein the historical sensing data includes normal historical sensing data and abnormal historical sensing data;
determine the division condition corresponding to the piece of target data based on the historical sensing data and the piece of target data;
generate at least one network data packet and at least one network route based on the piece of target data, the data anomaly feature of the piece of target data, and the division condition; and
transmit the at least one network data packet to the at least one target sub-platform through the at least one network route.

17. The system of claim 16, wherein the emergency supervisory management platform is further configured to:
determine an abnormal duration distribution of the sensor based on the historical sensing data;
determine an incident phase of the piece of target data based on the historical sensing data and the piece of target data;
determine data upload parameters for a next preset period based on the piece of target data, the incident phase, and the abnormal duration distribution; and
generate a sensor control instruction based on the data upload parameters, transmit the sensor control instruction to the emergency supervisory object platform, and control the sensor to operate according to the data upload parameters.

18. The system of claim 17, wherein the emergency rescue vehicle is equipped with a display component, and the emergency supervisory management platform is further configured to:
generate a display instruction based on the incident phase of the piece of target data, transmit the display instruction to the emergency supervisory object platform, and control the display component to operate based on the display instruction.

19. The system of claim 16, wherein the division condition further includes at least one sub-division condition of the at least one incident corresponding to the piece of target data, and the emergency supervisory management platform is further configured to:
for each incident in the at least one incident:
obtain at least one piece of associated data corresponding to the incident and the piece of target data;
determine a sub-division condition corresponding to the incident based on the piece of target data, the historical sensing data of the piece of target data, and associated historical sensing data corresponding to the at least one piece of associated data;
determine the at least one target sub-platform corresponding to the piece of target data based on the data anomaly feature of the piece of target data and the sub-division condition;
generate the at least one network data packet and the at least one network route based on the piece of target data, the data anomaly feature of the piece of target data, and the sub-division condition; and
transmit the at least one network data packet to the at least one target sub-platform through the at least one network route.
